(19) United States
(12) Patent Application Publication
(10) Pub. No.: US 2004/0236705 A1
(43) Pub. Date: Nov. 25, 2004

(54) Device accounting system

(76) Inventors: Toshihiro Shima, Nagano-ken (JP); Kyoichi Kamijima, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/789,416

(22) Filed: Feb. 26, 2004

(30) Foreign Application Priority Data
Feb. 27, 2003 (JP) 2003-051106
Feb. 25, 2004 (JP) 2004-048989

(51) Int. Cl. G06F 17/00; G06G 7/00; G06K 1/00; G06F 15/00; B41F 1/00; B41B 1/00; B41J 1/00

(52) U.S. Cl. 705/400; 358/1.15

(57) ABSTRACT

A usage control apparatus and a device in a fee system for a device are provided. The usage control apparatus and the device allow to charge depending on usage without having to access a server 20 during use. An issuing module 21 of server 20 collects payment from a client 30, and issues a predetermined amount of money information 51. When client 30 uses a printer 40 or other device, it appends to the print data 52 the money information 51 required for use (here, for printing), and sends it to the printer 40. If money information 51 in the amount required for printing is transmitted to the printer 40, it performs printing.

### BACKGROUND OF THE INVENTION

1. Field of the Invention

The present invention relates to a device, and to a usage control apparatus for controlling usage of the device.

2. Description of the Related Art

Devices, such as printers for example, consume paper and toner in the course of their use; accordingly, to date there exist systems for charging for usage of a printer, on a metered use basis. For example, in the system taught in JP2002-351777A, a user issues a print request to a server via a network. The server receiving the print request then issues a print command to a printer. The server issues the print command on the one hand, while calculating the number of print jobs and number of pages printed by the user.

However, when monitoring and assessing fees for usage of a printer or other device is performed by a server, it is necessary for the client using the device in question, or the device itself, to access the server during the process, and this creates the problem of imposing a burden on the network.

The present invention is intended to address this problem, and has as an object to provide a usage control apparatus and a device in a device accounting system, whereby it is possible to charge depending on usage, without having to access a server during use.

### SUMMARY OF THE INVENTION

The invention in a first aspect thereof provides a usage control apparatus for controlling use of a device, the apparatus having the following arrangement. That is, the usage control apparatus comprises: a holding module configured to hold money information requested when the device is made to perform a process that uses the device for predetermined usage; and a transmitting module configured to transmit the money information to the device at the time of processing by the device.

In preferred practice, the transmitting module transmits to the device process data for processing by the device.

The usage control apparatus may additionally comprise a controller configured to control whether the processing may proceed or not, by comparing the amount of processing specified by the process data, with the allowable amount of processing indicated by the money information.

The usage control apparatus may additionally comprise a money information updating module configured to update the money information according to an amount of processing specified by the process data.

The transmitting module may transmit the money information in an amount required for an amount of processing specified by the process data.

The transmitting module may transmit the money information held by the holding module. The usage control apparatus further may comprise a receiving module which receives from the device an updated value of the money information updated according to an amount of processing specified by the process data.

In one aspect, the device may be a printer, and the process data may be print data.

The holding module may preferably acquire and hold the money information from a server connected via a network.

In another aspect, the holding module may notify the server of an amount of money information that has not been used.

It is preferable that, in case where the money information includes control information which is usable for determining whether the money information is useable, the usage control apparatus further comprises a transmission controller which decides, based on the control information, whether the money information is useable, and if the money information is not useable, prohibits transmission of the money information.

The money information may be coin information permitting unit-based use of the device.

The usage may be established based on at least one selected from an amount of data processed by the device; consumed amount of an expendable consumed by the device; duration of use of the device; power consumed by the device; and number of times of use of the device.

The invention in another aspect thereof provides a usage control apparatus for controlling use of a device that requests predetermined money information depending on usage, the apparatus having the following arrangement. That is, the usage control apparatus comprises: a holding module configured to acquire, from a server connected to the usage control apparatus via a network, money information in an amount requested for using the device by a predetermined amount, and to hold the money information; and a transmitting module configured to transmit to the device process data for processing by the device. The transmitting module further transmits to the device, from the money information held by the holding module, the money information in at least an amount requested for causing the device to process the process data.

In this aspect, when processing is performed by the device by means of an instruction from the usage control apparatus, with respect to money information, there is no need for data to be sent and received between the usage control apparatus and the server. It is therefore possible to reduce the amount of data communications between the server and the usage control apparatus.

It is preferable that the transmitting module transmits to the device, together with the process data, the money information in an amount requested for causing the device to process the process data. It is also preferable that the usage control apparatus further comprises an updating module which updates the money information held in the holding module by deducting the money information in an amount transmitted to the device.

In this aspect, data for processing by the device, and money information corresponding with this process data, is transmitted to the device. Thus, it is not necessary for the device to request needed money information to the usage control apparatus, or for the device to respond to the usage control apparatus with excessive money information. It is therefore possible to reduce the amount of data communications between the server and the usage control apparatus.

The transmitting module may transmit to the device all the money information held in the holding module. In the arrangement, it is preferable that the usage control apparatus further comprises: a receiving module configured to receive from the device the money information that has been transmitted to the device and was deducted in an amount requested for causing the device to process and to store the money information in the holding module.

In this aspect, there is no need for processing money information in the usage control apparatus. Thus, money information may consist of data of a kind not processable by the usage control apparatus, and by so doing it is possible to prevent improper use in the usage control apparatus.

The invention in another aspect thereof provides a device having the following arrangement. The device comprises: a process command receiving module configured to receive a process command from a usage control apparatus for controlling a process; a decision module configured to decide whether or not to enable the process based on the process command, depending on whether money information requested when the device performs the process that uses the device for predetermined usage is held in the device and/or in the usage control apparatus; and a processing module configured to perform the process, in the event that the decision module has decided to enable processing.

The device preferably receives process data targeted for the process as the process command.

It is also preferable that the device further comprises: a managing module configured to manage the money information; and a updating module configured to update the money information depending on the amount of processing specified by the process data.

In one aspect, the device further comprises a redelivery module which transmits to the usage control apparatus an updated value of the money information that has been updated according to an amount of processing specified by the process data.

In another aspect, the device may further comprise: an output module configured to output, on the device and/or on the usage control apparatus, an amount of money information that has been requested and used for the process, and/or an amount of money information that has not been used and is held by the device and/or the usage control apparatus.

The output module, in the event of outputting the amount of unused money information, preferably outputs an amount of money information useable by the usage control apparatus.

The device may be a printer, and the process data may be print data.

The device may preferably further comprise a receiving module which receives the money information at the time of execution of the process.

It is also preferable that, in case where the money information includes control information for determining whether the money information is useable, the device further comprises a process prohibiting module which decides, based on the control information, whether the money information is useable, and if decided not useable, prohibits the process.

The money information may be coin information permitting unit-based use of a fixed usage.

The usage may be established based on at least one selected from the amount of data processed by the device; consumed amount of an expendable consumed by the device; duration of use of the device; power consumed by the device; and number of times of use of the device.

It is preferable that, in case where the money information is encrypted, the device further comprises: a key holding module which holds a key capable of decrypting the encrypted money information; and a decrypting module which decrypts the encrypted money information with the key.

The invention in another aspect thereof provides a device for executing processing in exchange for money information, having the following arrangement. That is, the device comprises: a holding module which receives, from a usage control apparatus connected to the device, money information in an amount for using the device for predetermined amount and holds the money information; a receiving module receives process data for processing from the usage control apparatus; a processing module able to execute the process; and a decision module that, in the event that an amount of money information required for processing the process data is less than an amount of money information held in the holding module, causes the processing module to execute the process.

With this aspect, by sending and receiving data between the device and the usage control apparatus, processing requiring predetermined money information depending on the amount of processing can be performed by the device within a certain predetermined scope.

It is preferable that the device further comprises: a transmitting module which transmits to the usage control apparatus money information that has been held in the holding module and was deducted money information in an amount required for processing of the process data.

With this aspect, the money information is processed on the device end, there is no needs for the usage control apparatus to process the money information. Thus, money information may consist of data of a kind not processable by the usage control apparatus, and by so doing it is possible to prevent improper use in the usage control apparatus.

The device may further comprise an updating module which updates the money information by deducting money information in an amount required for processing of the process data from the money information held in the holding module.

In this aspect, since there is no need to perform processing and retention of money information on the device end, it is not necessary for money information to be held in the usage control apparatus. Accordingly, it is possible to prevent improper use in the usage control apparatus.

The various features of the invention described hereinabove may be combined, or eliminated in part, as appropriate when reducing the invention to actual practice. Accordingly, the invention is not limited to the specific arrangements set forth hereinabove, and may realized in various other modes, such as a control method realized by a usage control apparatus or device having the functions described hereinabove, for example.

The invention may be provided as a computer program whereby the aforementioned functions are realized by a computer. A computer-readable recording medium having such a computer program recorded thereon is also possible. In this case, the recording medium may be a flexible disk, CD-ROM, DVD-ROM, magnetooptical disk, IC card, ROM cartridge, punch card, printed matter imprinted with symbols such as a bar code, a computer internal storage device (RAM, ROM or other memory) or external storage device, or other computer-readable medium.

These and other objects, features, aspects, and advantages of the present invention will become more apparent from the following detailed description of the preferred embodiments and the accompanying drawings.

### BRIEF DESCRIPTION OF THE DRAWINGS

FIG. 1 is a function block diagram of a printer fee system in Embodiment 1;

FIG. 2 is a flowchart of the money information issuing process in Embodiment 1;

FIG. 3 is a flowchart of the printing process in Embodiment 1;

FIG. 4 is a flowchart of the printing process in Variant Example 1 of Embodiment 1;

FIG. 5 is a flowchart of the printing process in Variant Example 2 of Embodiment 1;

FIG. 6 is a flowchart of the printing process in Variant Example 3 of Embodiment 1;

FIG. 7 is a function block diagram of a printer fee system in Embodiment 2;

FIG. 8 is a flowchart of the printing process in Embodiment 2;

FIG. 9 is a function block diagram of a printer fee system in Embodiment 3;

FIG. 10 is a flowchart of the money information 51 issuing process in Embodiment 3; and

FIG. 11 is a flowchart of the printing process in Embodiment 3.

### DETAILED DESCRIPTION OF THE PREFERRED EMBODIMENTS

The preferred embodiments of the invention are described hereinbelow according to the following outline.

A. Embodiment 1

A1: Function Block:

A2: Processing:

A3: Effects:

A4. Variant Example 1 of Embodiment 1:

A6: Effects of Variant Example 1 of Embodiment 1:

A6. Variant Example 2 of Embodiment 1:

A7: Effects of Variant Example 2 of Embodiment 1:

A8. Variant Example 3 of Embodiment 1:

A9: Effects of Variant Example 3 of Embodiment 1:

B. Embodiment 2

B1: Function Block:

B2: Processing:

B3: Effects:

C. Embodiment 3

C1: Function Block:

C2: Processing:

C3: Effects:

D. Variant Examples

A. Embodiment 1

A1: Function Block:

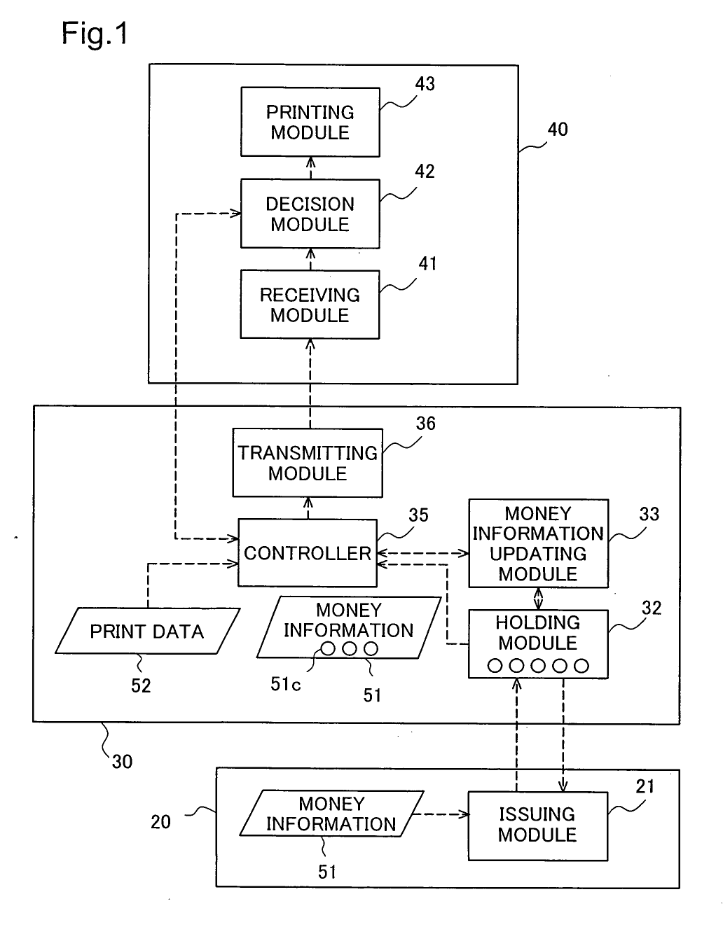

In the description of this embodiment, the device is a printer. FIG. 1 is a function block diagram of a printer fee system in Embodiment 1. The printer fee system comprises a server 20, a client 30, and a printer 40, which are connected by a network. Server 20 and client 30 are connected to the Internet; client 30 and printer 40 are connected on a LAN. Alternatively, a local connection may be provided for client 30 and printer 40. While not shown in FIG. 1, a plurality of clients 30 and of printers 40 are present.

An issuing module 21 of server 20 issues money information 51 in response to a request from a holding module 32 of client 30. Money information 51 is requested by the printer 40 when client 30 sends a print request to printer 40, and represents an amount of money corresponding to a certain amount of processing. Prior to printing, client 30 purchases money information 51 from the issuing module 21 of server 20. During printing, money information 51 of each client is consumed depending on the amount of processing.

Money information 51 consists of objectified coin information 51c. It is set up such that three pages can be printed per single unit of coin information 51c. That is, in exchange for the client performing printing of three pages of printer paper, one unit of coin information 51c is consumed from the money information 51 of client 30. The number of pages that can be printed with a single unit of coin information 51c is not limited to three; two or fewer pages, or four or more pages, would be possible instead. Consumed toner quantity or printer 40 usage time may also be established in a unit of coin information 51c. That is, there can be established an arrangement wherein one unit of coin information 51c is consumed from money information 51 in association with consumption of a predetermined quantity of toner; or one unit of coin information 51c is consumed from money information 51 in association with use of the printer for a usage time of predetermined duration. When issuing money information 51, a sum dependent on the amount of money information 51 issued by server 20 is collected from the client 30.

The holding module 32 of client 30 holds and manages the acquired money information 51. The controller 35 decides whether to allow processing to proceed, by comparing the number of print pages specified by print data 52, with the number of print pages permitted by the remaining balance (in FIG. 1, five units of coin information 51c) of the money information 51 held in the holding module 32. In the event of a decision to enable printing, the controller 35 requests the holding module 32 for the amount of money information 51 required for printing (in FIG. 1, three units of coin information 51c). A money information updating module 33 deducts the amount used for printing (three units of coin information 51c) from the money information 51. A transmitting module 36 transmits to printer 40 the print data 52 and the amount of money information 51 used for printing (three units of coin information 51c).

A receiving module 41 of printer 40 receives from the transmitting module 36 of client 30 the print data 52 and money information 51. A decision module 42 decides that printing is permitted, in the event that the number of printable pages indicated in the received money information 51 is equal to or greater than the number of print pages specified by the print data 52. In the event that decision module 42 decides that printing is permitted, printing module 43 performs printing.

A2: Processing:

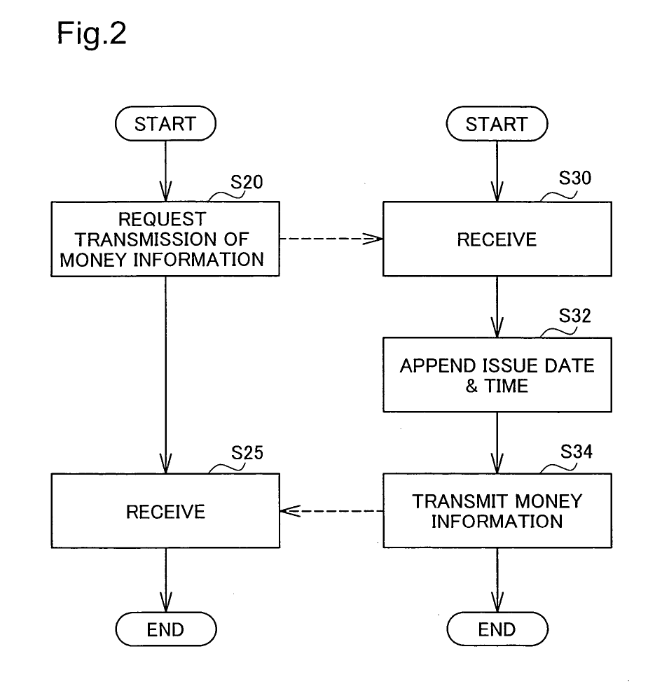

FIG. 2 is a flowchart of the money information issuing process in Embodiment 1. At left is a flowchart for the client 30; at right is a flowchart for the server 20. First, prior to printing, the holding module 32 of client 30 sends a request to transmit money information 51 to issuing module 21 of server 20 (Step S20). The charge for issuing money information 51 is paid by means of credit card payment, bank transfer, or the like. At the time that the transmission request is made, the server may be notified of any unused money information.

The issuing module 21 of the server 20, having received the money information transmission request (Step S30), appends the current time by second, to money information 51 already held (Step S32), and sends the money information 51 for the paid amount to the holding module 32 of the client 30 which has requested transmission (Step S34). That is, the client 30 receives the requested amount of money information 51, together with “current time” representing the time at which the money information 51 was issued.

“Current time” can be used in order to avoid illegal copying or other improper use of money information 51. Besides current time, money information 51 transmitted to client 30 may have appended thereto printer 40-specific information, user ID of the user, or client 30-specific information. The money information 51 may also have appended thereto information indicating “unlimited use permitted”; or where an expiration period is to be associated with money information 51, an expiration period may be appended.

The holding module 32 of client 30 receives (Step S25) and manages money information 51 transmitted by the issuing module 21 of server 20.

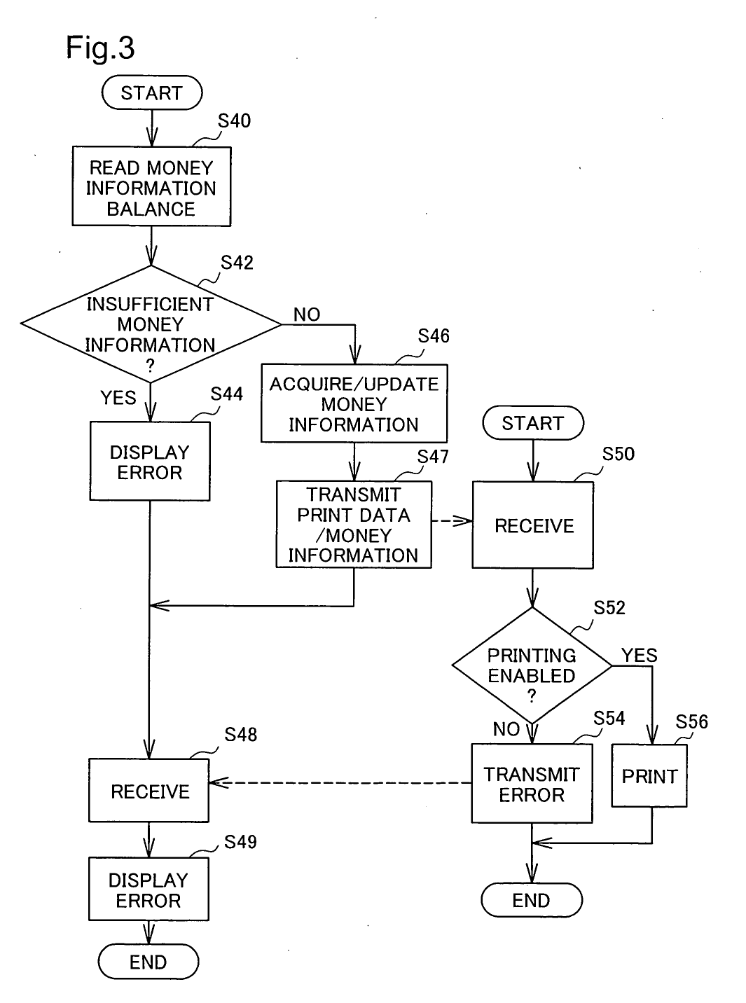

FIG. 3 is a flowchart of the printing process in Embodiment 1. At left is a flowchart for the client 30; at right is a flowchart for the printer 40. First, the controller 35 of client 30 reads out the remaining balance (in FIG. 1, five units of coin information 51c) of money information 51 held in the holding module 32 (Step S40), and compares the number of print pages specified by the print data 52 with the number of pages possible to print with the remaining balance of money information 51.

In the event that the number of pages possible to print with the remaining balance of money information 51 is fewer than the number of print pages specified by the print data 52 (Step S42), money information 51 is deemed insufficient, and an error display is generated (Step S44). A prompt to purchase money information 51 from holding module 32 may be displayed together with the error display. By so doing, the processes for printing can continue.

In the event that the number of pages possible to print with the remaining balance of money information 51 is more than the number of print pages specified by the print data 52 (Step S42), since there is sufficient money information 51, the controller 35 now acquires from holding module 32 money information 51 commensurate with the number of pages to be printed (Step S46). Here, since it is possible to print three pages with a single unit of coin information 51c, controller 35 acquires two units of coin information 51c in the event that there are six pages to be printed, acquires three units of coin information 51c in the event that there are seven pages to be printed, or acquires three units of coin information 51c in the event that there are eight pages to be printed. That is, where money information 51 is composed of predetermined units, such as coin information 51c, “money information 51 in an amount required in exchange for processing of process data by a device such as a printer 40” refers to the minimum required amount of money information for the process data to be processed by the device. Here, the number of pages to be printed is seven. Accordingly, controller 35 acquires three units of coin information 51c.

Once the controller 35 has acquired three units of coin information 51c, it instructs the money information updating module 33 to decrement by three the coin information 51c held in holding module 32. In accordance with this instruction, the money information updating module 33 updates the remaining balance of money information 51 held in holding module 32 (Step S46). Since holding module 32 has been holding five units of coin information 51c, the remaining balance of coin information 51c is now 2 (=5−3).

The transmitting module 36 receives from the controller 35 the print data 52 and the three units of coin information 51c, and sends these to the receiving module 41 of the printer 40 (Step S47).

The receiving module 41 of the printer 40 receives the print data 52 and money information 51 (Step S50). The decision module 42 of printer 40 compares the number of pages for printing specified by the print data 52, and the number of printable pages indicated by the received money information 51, and decides whether the print data 52 can be printed.

In the event that the number of printable pages indicated by the received money information 51 exceeds the number of pages for printing specified by the print data 52 (Step S52), since there is sufficient money information 51, the printing module 43 performs printing (Step S56). Here, since there are three units of coin information 51c for seven pages to be printed, printing is carried out.

In the event that the number of printable pages indicated by the received money information 51 is fewer than the number of pages for printing specified by the print data 52 (Step S52), money information 51 is deemed insufficient, and an error is transmitted to client 30 (Step S54).

Upon receiving an error, client 30 displays an error message (Step S49). Here, money information 51 may be acquired from holding module 32 at the same time that the error message is displayed.

The process of either Steps S42, S44 or the process of Steps S52, S54, S48, S49 may be carried out; it is not necessary to perform both.

A3. Effects

According to Embodiment 1 hereinabove, it is possible to carry out fee management depending on the amount of processing by the printer, without the need to access the server 20, as long as payment is collected for issuance of money information 51. In other words, since money information 51 corresponding to the total charges for printings is issued prior to the printings, there is no need for the server 20 and the client 30 to communicate regarding money information 51 each time that printing is performed. That is, fee management can be carried out while reducing the load on the network.

A4. Variant Example 1 of Embodiment 1:

In Variant Example 1, once transmitting module 36 has sent the print data 52 and money information 51 acquired from holding module 32 to the printer 40, the money information updating module 33 deduct money information 51 commensurate to that requested to the holding module 32.

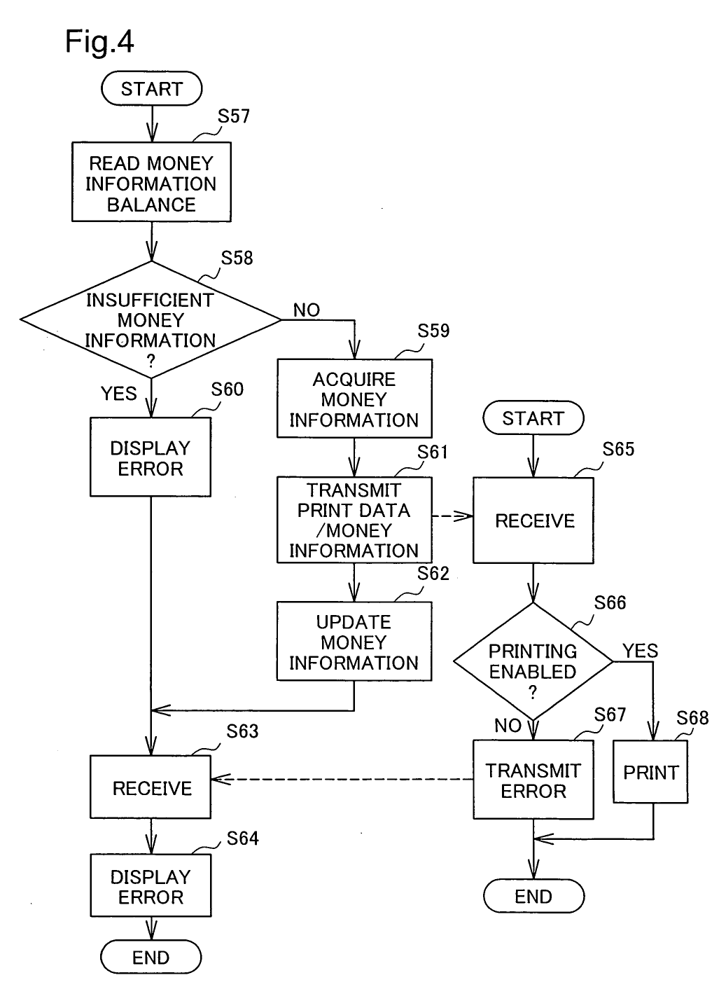

FIG. 4 is a flowchart of the printing process in Variant Example 1 of Embodiment 1. At left is a flowchart for the client 30; at right is a flowchart for the printer 40.

As in Embodiment 1, in the event that the number of pages printable with the remaining balance of money information 51 exceeds the number of pages for printing specified by the print data 52 (Step S58), since there is sufficient money information 51, the controller 35 now acquires from holding module 32 money information 51 commensurate with the number of pages to be printed (Step S59). Once the controller 35 acquires three units of coin information 51c, it transfers them to the transmitting module 36. The transmitting module 36 receives from the controller 35 the print data 52 and three units of coin information 51c required for the number of pages to be printed, and sends them to the receiving module 41 of the printer 40 (Step S61).

Next, controller 35 instructs the money information updating module 33 to decrement the coin information 51c held in the holding module 32. In accordance with this instruction, the money information updating module 33 updates the remaining balance of money information 51 held in the holding module 32 (Step S62).

A5: Effects of Variant Example 1 of Embodiment 1:

According to Variant Example 1, since money information 51 is updated subsequent to being sent, the money information 51 will not be updated in the event of an error in transmission of the money information 51 or print data 52.

A6. Variant Example 2 of Embodiment 1:

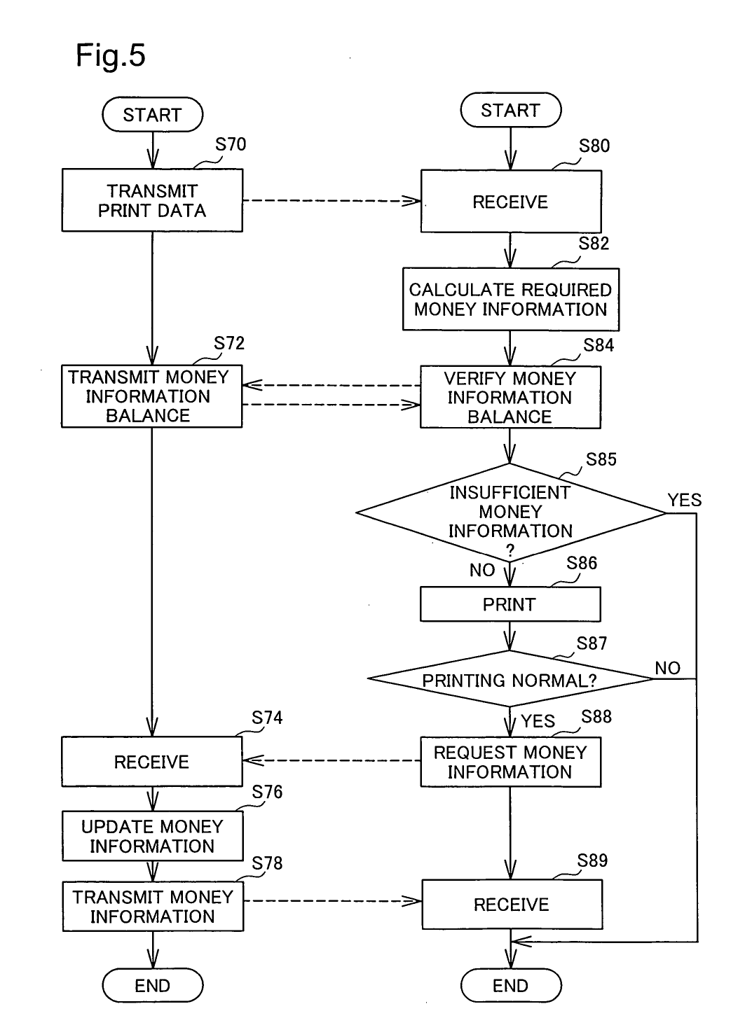

FIG. 5 is a flowchart of the printing process in Variant Example 2 of Embodiment 1. At left is a flowchart for the client 30; at right is a flowchart for the printer 40. First, the transmitting module 36 of client 30 transmits print data 25 to the receiving module 41 of printer 40.

Once the receiving module 41 of printer 40 receives the print data 52 (Step S80), the decision module 42 calculates the number of units of coin information 51c required to print the print data 52 (Step S82). Here, since it can be identified that there are seven pages to be printed by print data 52, three units of coin information 51c are required. Next, the decision module 42 verifies the remaining balance of money information 51, with the controller 35 of client 30 (Step S84).

When the controller 35 of client 30 receives an instruction to verify the remaining balance of money information 51 (Step S72), verification of the remaining balance is carried out with reference to holding module 32, and the remaining balance is transmitted to the decision module 42 of printer 40 (Step S72). Here, “five units” of coin information 51c are transmitted.

In the event that the decision module 42 of printer 40 decides that the remaining balance of money information 51 in holding module 32 received from controller 35 is greater than the number calculated in Step S82 (Step S85), the controller 43 carries out printing of the print data 52 (Step S86). If printing completes normally (Step S87), the decision module 42 of printer 40 requests the controller 35 of client 30 for the money information 51 which is required (Step S88). Here, three units of coin information 51c are requested.

Once the controller 35 of client 30 receives the request for money information 51 (Step S74), it acquires three units of coin information 51c from holding module 32. Money information updating module 33 is then instructed to decrement by three the coin information 51c held by the holding module 32. In accordance with this instruction, the money information updating module 33 updates the remaining balance of money information 51 held by holding module 32 (Step S76). Transmitting module 36 receives money information 51 from the controller, and transmits the money information 51 to the decision module 42 of printer 40 (Step S78).

Once the decision module 42 of printer 40 receives the money information 51 (Step S89), the process terminates.

On the other hand, in the event that the remaining balance of money information 51 is smaller than the number calculated in Step S82 (Step S85), the decision module 42 of printer 40 terminates the routine without doing anything. At this time, an error may be sent to client 30.

A7: Effects of Variant Example 2 of Embodiment 1:

According to Variant Example 2, since money information 51 is requested after printing has been completed by the printer 40, the client 30 will suffer no loss, even if an error in printing occurs.

A8. Variant Example 3 of Embodiment 1:

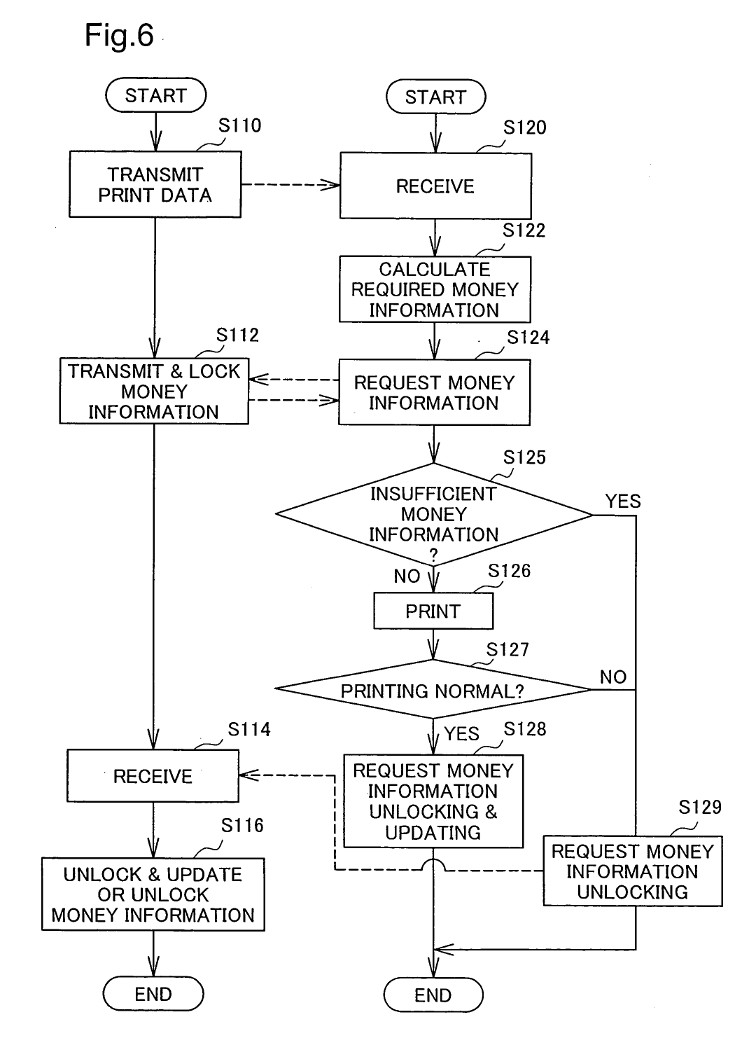

FIG. 6 is a flowchart of the printing process in Variant Example 3 of Embodiment 1. At left is a flowchart for the client 30; at right is a flowchart for the printer 40. In Variant Example 3, decision module 42, after calculating the money information required for printing the print data (Step S122), requests the controller 35 of client 30 for the required money information 51 (Step S124).

Once the controller 35 of client 30 receives a request for money information 51 (Step S112), it requests the holding module 32 for money information 51, and sends the required amount of coin information 51c to the decision module 42 of printer 40 (Step S112). It then locks the transmitted amount of coin information 51c (Step S112). Here, locking refers to holding the transmitted coin information 51c data together with the attribute “transmitted”, in non-modifiable form.

If the decision module 42 of printer 40 the received coin information 51c is not insufficient (Step S125), the printer module 43 performs printing of the print data 52 (Step S86). If printing completes normally (Step S127), the controller 35 of client 30 is requested to unlock the required coin information 51c and update the money information (Step S128).

When the controller 35 of client 30 receives a request to unlock the required coin information 51c and update the money information (Step S114), it unlocks the coin information 51c (Step S116), and instructs the money information updating module 33 to decrement, by the required amount, the coin information 51c held in the holding module 32, i.e. by the amount transmitted to the decision module 42 of printer 40. In accordance with this instruction, the money information updating module 33 updates the remaining balance of money information 51 held in holding module 32 (Step S116).

If the received coin information 51c is insufficient (Step S125), the decision module 42 of printer 40 request only unlocking of coin information 51c (Step S129). Even if printing does not complete normally (Step S127), only unlocking of coin information 51c is requested (Step S129).

Once controller 35 of client 30 receives a request to unlock the required coin information 51c (Step S114), it unlocks the coin information 51c (Step S116).

A9: Effects of Variant Example 3 of Embodiment 1:

According to Variant Example 3, money information 51 is locked, and a request to update money information 51 is made after completion of printing by the printer 40, so no loss is suffered even if an error occurs in printing.

B. Embodiment 2

B1. Function Block

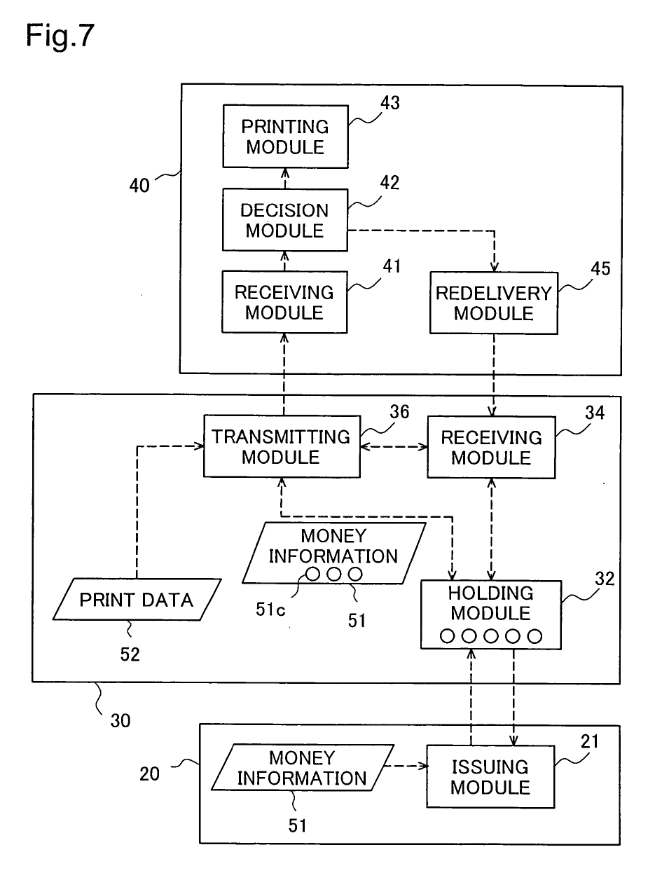

FIG. 7 is a function block diagram of a printer fee system in Embodiment 2. The client transmitting module 36 transmits to the printer 40 the print data 52, and all of the money information 51 held by the holding module 32. The decision module 42 of printer 40 calculates the number of units of coin information 51c required for the number of print pages specified in the received print data 52. A redelivery module 45 deducts the required coin information 51c from the received money information 51, and redelivers it to the client 30. The receiving module 34 of the client 30 receives the residual money information 51 redelivered by the redelivery module 45.

The money information 51 issued by the server 20 is information that has been encrypted by the server 20, and is recognizable as money information 51 only to the holding module 32, transmitting module 36, and receiving module 34 in client 30.

B2. Processing:

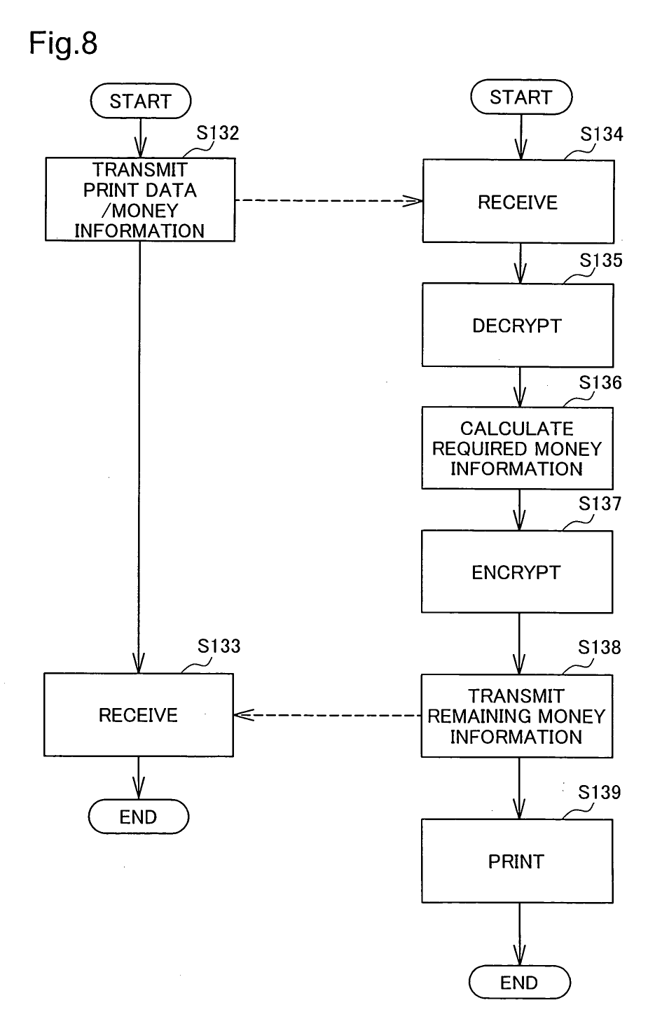

FIG. 8 is a flowchart of the printing process in Embodiment 2. At left is a flowchart for the client 30; at right is a flowchart for the printer 40. First, the transmitting module 36 of client 30 transmits to the receiving module 41 of printer 40 (Step S132) the remaining balance of money information 51 held by the holding module 32 and print data 52 appended with an ID which identifies the transmitting module 36 of client 30. Here, since five units of coin information 51c are available, five units of coin information 51c are transmitted.

The receiving module of printer 40 receives the print data 52 and money information 51 (Step S134), and decrypts the encrypted money information (Step S135). The key required for decrypting money information is generated in advance by the server 20 and transmitted to the printer 40, where it is stored in the receiving module 41. The key may instead be transmitted to the printer 40 via the client 30, or sent directly from the server 20 to the printer 40 over the Internet. The decision module 42 of the printer 40 calculates the number of units of coin information 51c required, from the number of pages for printing specified by the print data 52 (Step S136). Here, since the number of pages for printing specified by the print data 52 is seven, the required number of units of coin information 51c is three.

The redelivery module 45 deducts the coin information 51c required to print, encrypts the residual money information 51 (Step S137), and sends it to the receiving module 34 of the client 30 identified by the ID (Step S138). Here, two units (=5−3) of coin information 51c are sent. The printing module 43 prints the print data 52 (Step S139). The receiving module 34 of the client 30 receives the residual money information 51 (Step S133).

During normal printing, processes of Steps S137, 138, 133 may be absent in some instances. It is not necessary to redeliver residual money information 51 each time that printing is performed; instead, redelivery could take place during a single calculation performed daily. In this case, residual money information 51 would be used when printing is next performed.

B3. Effects:

According to Embodiment 2 hereinabove, since money information 51 undergoes no particular modification by client 30, money information 51 is sent to the client 30 after being encrypted by the server 20 which issues the money information 51, or by the printer 40. Accordingly, the risk of improper modification of money information 51 by a client 30 is diminished. Additionally, printing can be carried out without any particular awareness of the amount of processing by client 30. That is, in client 30, there is no verification of the number of printable pages, as in Steps S40, S42 of FIG. 3. Accordingly, there is less load on the client 30.

C. Embodiment 3

C1: Function Block:

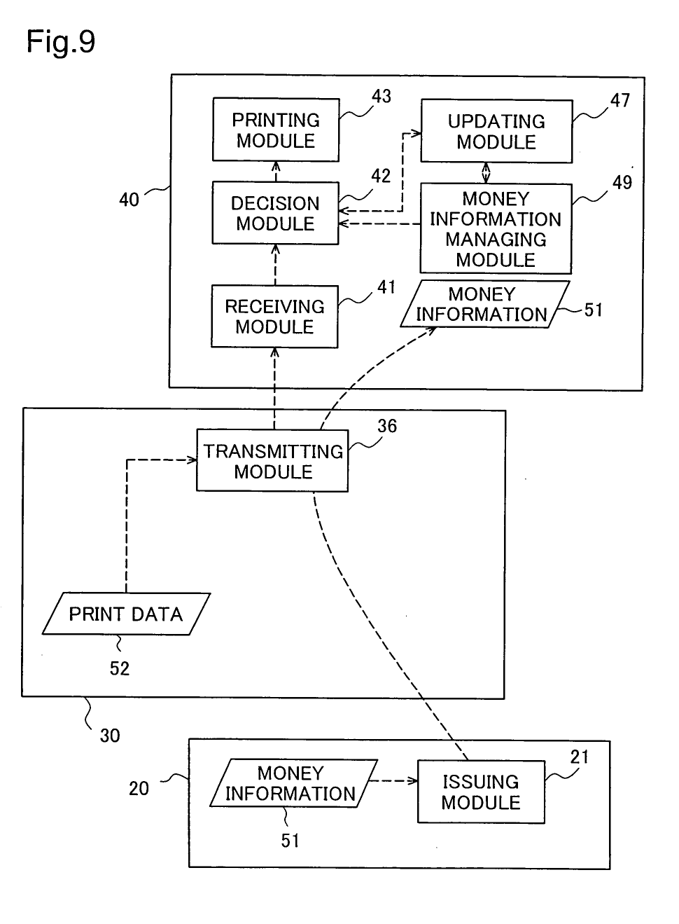

FIG. 9 is a function block diagram of a printer fee system in Embodiment 3. In response to a request from client 30, the issuing module 21 of server 20 issues money information 51. The transmitting module 36 of client 30 transmits the money information 51 issued by issuing module 21, as-is to the receiving module 41 of printer 40.

The money information managing module 49 of printer 40 holds and manages the money information 51 received by the receiving module 41. Decision module 42 compares the number of pages for printing specified by the print data 52 sent by the client 30, with the number of pages printable by means of remaining balance of money information 51 for client 30, held in the money information managing module 49; and then decides whether to enable printing. In the event of a decision to enable printing, the money information managing module 49 is requested for money information 51 in the amount required for printing. Updating module 47 then decrements the money information 51 by the amount used in printing.

C2: Processing:

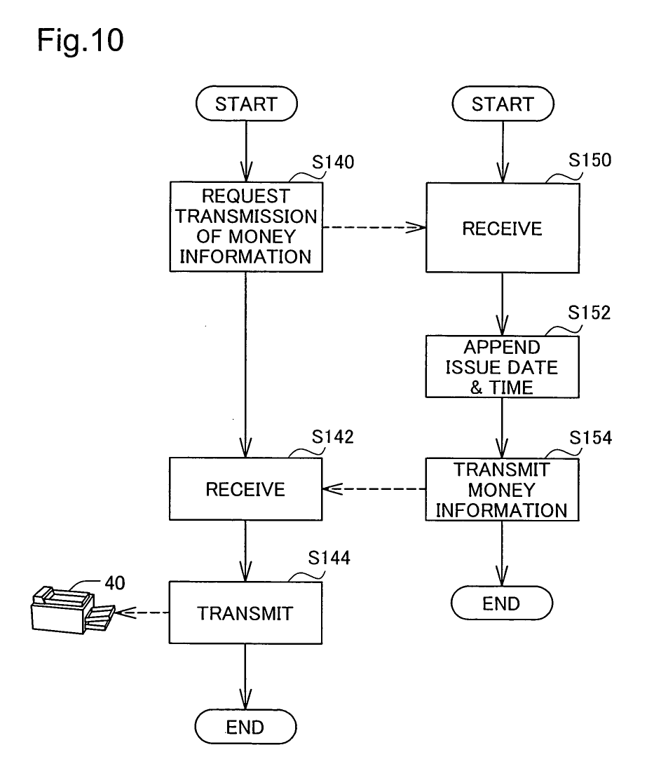

FIG. 10 is a flowchart of the money information 51 issuing process in Embodiment 3. At left is a flowchart for the client 30; at right is a flowchart for the server 20. First, client 30 sends a request to transmit money information 51 to issuing module 21 of server 20 (Step S140).

The issuing module 21 of the server 20, having received the transmission request for money information 51 (Step S150), appends the “current time” to money information 51 already held (Step S152), and transmits the money information 51 to the client 30 that sent the transmission request (Step S154). That is, the client 30 receives the requested amount of money information 51, together with “current time” representing the time at which the money information 51 was issued. At this time, the money information 51 is encrypted for transmission.

As in Embodiment 1, the money information 51 sent to client 30 may have appended thereto printer 40-specific information, user ID of the user, or client 30-specific information. The money information 51 may also have appended thereto information indicating “unlimited use permitted”; or where an expiration period is to be associated with money information 51, an expiration period may be appended.

Transmitting module 36 of client 30 receives the money information 51 transmitted by the issuing module 21 of server 20 (Step S142), places in memory only the “current time” appended to the money information 51 (i.e. the issuing time of the money information 51 in question), and transmits the money information 51 as-is to printer 40 (Step S144). The receiving module 41 of printer 40 receives the money information 51 and decrypts the money information 51. The printer 40 stores the money information 51 appended with “current time” as identifying information for each of the clients.

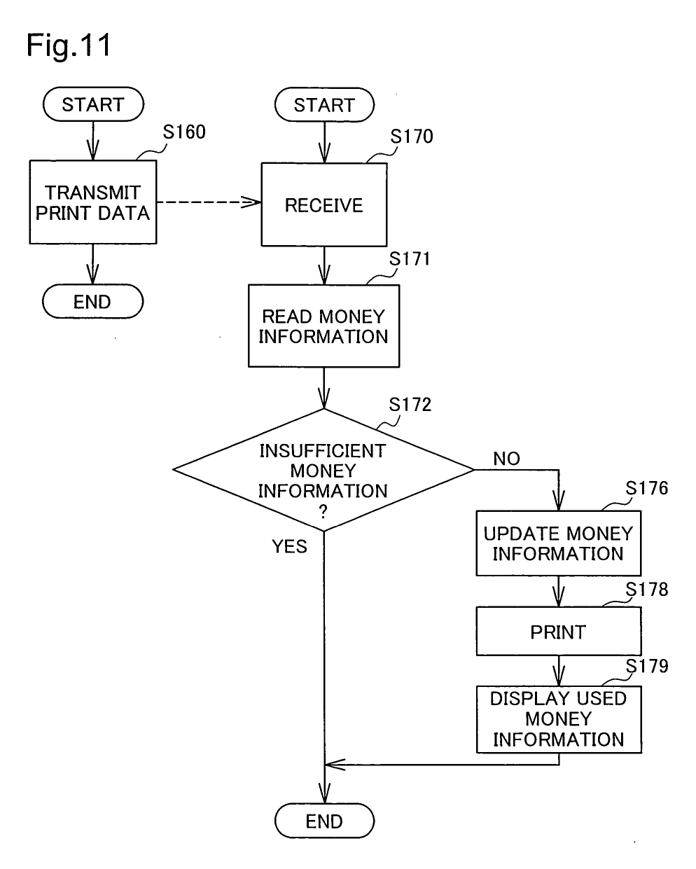

FIG. 11 is a flowchart of the printing process in Embodiment 3. At left is a flowchart for the client 30; at right is a flowchart for the printer 40. First, the transmitting module 36 of client 30 appends to the print data 52 the “current time” which was placed in memory in Step S144, and transmits the data to the receiving module 41 of printer 40 (Step S160).

When the receiving module 41 of printer 40 receives the print data 52 (Step S170), the decision module 42 reads, from the money information 51 for each client 30 held in the printer 40, money information 51 having appended thereto a “current time” that matches the “current time” appended to the print data 52 (Step S171). Since money information 51 for a number of clients 30 is present in printer 40, it identifies money information 51 for a particular client 30 by means of the “current time”. Identifying information is not limited to “current time”; as noted, some other value that identifies a particular client 30, such as the MAC address of the client 30, would be acceptable also.

Next, decision module 42 decides whether the number of pages printable with the remaining balance of money information 51 read on the basis of “current time” exceeds the number of pages for printing specified by the print data 52 (Step S172). If so (Step S172), since there is sufficient units in money information 51, the money information updating module 33 is instructed to deduct three units from the coin information 51c held in money information managing module 49.

In accordance with this instruction, the money information updating module 33 updates the remaining balance of money information 51 held in money information managing module 49 (Step S176). Printing module 43 then prints out the print data 52 (Step S178). After printing, the remaining balance of money information 51 is displayed on the control panel of printer 40 (Step S179). Where the client 30 and user are identifiable, the user or other information may be displayed concomitantly. Where the client 30 is identified, the information may be displayed on the screen of the client 30. The amount of money information used may be displayed, instead of the remaining balance. In the event that the number of printable pages is fewer than the number of pages to be printed, nothing is done; however, an error may be returned to client 30.

C3. Effects

According to Embodiment 3 hereinabove, money information 51 is managed by the printer 40, so that communication between the client 30 and printer 40 is reduced, thus reducing the load on the network. Additionally, since money information 51 is encrypted for transmission, improper access to money information 51 during transmission can be prevented.

Money information 51 may be sent directly from the server 20 to the printer 40. The destination printer 40 may be a printer 40 selected for use by the client 30, or a printer 40 which the client 30 is permitted to use by the server 20.

D. Variant Examples

While the invention has been shown and described hereinabove through embodiments, it is not limited thereto and may be reduced to practice in various other modes, without departing from the scope and spirit thereof.

For example, the usage control apparatus of the invention may be an embodiment comprising a holding module for holding money information requested when the device is made to perform a process that uses the device for a predetermined amount of processing; and a transmitting module for transmitting the money information to the device at the time of processing by the device.

According to this embodiment, by employing money information as information equivalent to cash in the real world, fee management according to usage of a device can be carried out, without having to notify the server of past usage of the device. That is, fee management can be carried out without imposing a load on the network. The load on the server entailed in managing past usage can be reduced as well.

While money information is equivalent to cash in the real world, the user of the usage control apparatus is not necessarily limited to making a deposit. For example, in a corporate setting, money information may be allocated to respective departments according to their printing budget.

In order to avoid improper copying, in the usage control apparatus, it is preferable for money information to be information recognizable only by a specific application program for transferring and administering money information with respect to devices.

“Time of processing” means any point in time during a series of processes in which processes are executed by a device; it includes various timings, such as prior to executing a process, or after completing a process, for example.

The transmitting module of the use control device may transmit process data for processing by the device to the device.

Where the device is a printer, for example, process data is equivalent to print data. Money information need not necessarily be transmitted simultaneously with process data. That is, money information and process data may be sent together to a device, or sent separately. The aforementioned time of processing includes just after the device has received process data.

The holding module of the usage control apparatus may acquire and hold the money information from a server connected with the network.

Where money information is distributed by a server over a network, convenience is afforded. However, the mode of money information acquisition is not limited to a network route; money information may be represented in the form of a bar code or numeric code, recorded on a card which is mailed in by the user.

Money information may be acquired from the server by the usage control apparatus, and transmitted from the usage control apparatus to a device during use of the device, or around this time.

The holding module of the usage control apparatus may notify the server of the unused amount of the money information.

With this arrangement, the server can be notified of the remaining balance of money information held by the usage control apparatus, and when the remaining balance is below a predetermined amount, money information can be distributed automatically to the usage control apparatus.

The usage control apparatus may comprise a controller for controlling whether processing takes place, by comparing the amount of processing specified by the process data with the amount of processing processable with the money information.

With this arrangement, in the event that money information is not sufficient for a given amount of processing, processing can be disabled so that process data is not transmitted to the device. By so doing, unnecessary communication can be reduced. It is also possible to prevent, prior to the fact, erroneous processing by a device of process data that should have been designated as non-processable, due to insufficient money information. In the event of a non-processable decision, the user may be prompted to replenish the money information.

On the other hand, where money information is smaller than an amount of processing, a device may be designated such that processing takes place of an amount of process data within limits of the range processable with the money information, and the processable portion of the process data transmitted to the device. Alternatively, a device may be designated such that processing takes place through processing within limits of the range processable with the money information. For example, a detailed print request may be processed at lower resolution.

Money information may consist of information that is valid for printing one time only. The usage control apparatus can further comprise a money information updating module for updating the money information according to the amount of processing specified by the process data.

According to such an embodiment, by updating money information, changes in cash on hand in the real world, that is, a decrease in cash on hand occurring with processing, or an increase in cash on hand occurring with withdrawal from a bank account, may be realized electronically. In such an embodiment, since it is unnecessary to replenish money information from the server each time that processing is performed, greater convenience is afforded. Updating may take place prior to transmitting process data to the device, or after transmitting. It may be carried out at various timing.

The transmitting module in the usage control apparatus may transmit the money information in an amount required for the amount of processing specified by the process data.

Where only the required amount of money information is transmitted, communication in order to send back the unneeded portion from the device to the usage control apparatus becomes unnecessary. Also, loss can be held to a minimum even if an error should occur during processing.

Transmission of money information may take place prior to processing of process data by the device, or after processing. Where it takes place after processing, loss suffered by the user can be avoided even if an error should occur during processing. Where money information is transmitted prior to processing, in the event that things do not go well during processing, the money information may be again returned from the device to the usage control apparatus.

The transmitting module of the usage control apparatus may transmit the money information held by the holding module, and the usage control apparatus may comprise a receiving module for receiving from the device an updated value of the money information having been updated according to the amount of processing specified by the process data.

Money information received by the receiving module corresponds to the change from deducting the device usage charge from the transferred money. According to such an embodiment, since the device calculates and gives back change, there is not need for “change” to be calculated by the usage control apparatus, affording a simple process. In particular, in cases where fare systems differ depending on the type of device, i.e., in cases where money information required for given process data differs on a device-by-device basis, this is an advantage, since it is possible to avoid complex processing by the usage control apparatus.

In a server for issuing money information, or in a device, by encrypting money information for transmission to the usage control apparatus, it is possible to minimize the likelihood of improper modification of the money information by the usage control apparatus.

A device need not give back “change” to the usage control apparatus each time that a process is performed. Instead, for example, “change” could given back during a single calculation performed daily. Also, the usage control apparatus need not give back “change” to the server, instead holding it in its holding module. The “change” would then be used the next time that the device is used.

In the event that money information is transmitted to a device, money information may be transmitted irrespective of the amount of processing. For example, an embodiment wherein all money information held by the usage control apparatus is transmitted, or an embodiment wherein a pre-established amount of money information is transmitted, would be possible. By so doing, it becomes unnecessary for the usage control apparatus to calculate money information required on the basis of the amount of processing. Alternatively, residual money information from comparison with the amount of processing can be transmitted to a device. This is effective in cases such as where fare settings for use of a device are rather intricate.

Where, for example, use of a device up to a defined monetary amount per month is possible, a predetermined amount of money information may be transmitted to the device at the beginning of each month.

The device may be a printer, and the process data may be print data.

By so doing, while avoiding load on the network, fees may be charged according to the amount of processing by the printer.

The money information may include control information for determining whether to use the money information, a decision whether to use the money information may be made by means of the control information, and in the event of a decision that it cannot be used, transmission of the money information may be prohibited.

By so doing, use versus non-use can be controlled by a condition separate from the amount of processing of a device. For example, by appending a use period as control information to money information, it is possible to enable unlimited use of a device, or enable use for a specific use period, for specific individuals. Control information may also be information identifying a device; information identifying a usage control apparatus; information for controlling operation of a usage control apparatus; or information about a user who is requesting processing. Control information may also be a category of protocol, data or application.

The money information may be coin information permitting unit-based use of the device.

Coin information consists of objectified money information. For example, where the device is a printer, where three pages can be printed per single unit of coin information, if it is desired to print five pages, two units of coin information will be sent to the printer. In this arrangement, the control can be simple. In this case, since the number of printable pages remaining unused from the money information 51 sent to printer is quite small, in many instances, it is acceptable to not transmit the unused portion of the money information from the printer to the usage control apparatus.

On the other hand, even where the usage control apparatus transmits all coin information irrespective of amount of processing, so that surplus coin information is transmitted to the usage control apparatus by the device, the process is simple as long as object units are employed.

Money information is not limited to coin information; other information which is a variable representing amount of processing as a number value is acceptable.

The amount of processing may be established based on at least one selected from the amount of data processed by the device; consumed amount of an expendable consumed by the device; duration of use of the device; power consumed by the device; and number of times of use of the device.

On the other hand, the invention in an embodiment thereof as a device comprises:

a process command receiving module for receiving a process command from a usage control apparatus for controlling a process;

a decision module for deciding whether to enable a process based on the process command, depending on whether money information requested when the device performs a process that uses the device for predetermined usage is held in the device and/or the usage control apparatus; and

a processing module for performing the process, in the event that the decision module has decided to enable processing.

According to this device, it is possible to perform fee management depending on the usage of a device, without notifying the server of past processing. That is, fee management can be carried out while reducing the load on the network. The load on the server entailed in managing past usage can be reduced as well.

Where money information is held by the usage control apparatus, the usage control apparatus may be requested to reduce money information, simply when the process is performed and completes without incident. Where money information is handled by the usage control apparatus, in order to avoid improper copying of money information, the information should be recognizable only by a predetermined application.

As the process command, the device may receive process data for processing by the process.

There exist various devices for performing processes based on process data. For example, where the device is a printer, the process data corresponds to print data.

The device may comprise a receiving module for receiving the money information at the time of process execution.

By so doing, even if money information is not held in advance by a device, the information can be received from the usage control apparatus or server issuing the money information, so that the process may be executed. Money information may be received at the time of processing, or received prior to processing. Various timing for reception is possible.

The device may comprise

a managing module for managing the money information; and

a updating module for updating the money information, depending on the amount of processing specified by the process data.

In such an embodiment, since money information is managed by the device, the amount of communication between the usage control apparatus and device can be reduced, so that the load on the network is reduced. Where money information is received directly from the issuing server, improper modification of money information by the usage control apparatus is prevented.

In such an embodiment, by updating money information, changes in cash on hand in the real world, that is, a decrease in cash on hand occurring with processing, or an increase in cash on hand occurring with withdrawal from a bank account, may be realized electronically. In such an embodiment, since it is unnecessary to replenish money information from the server each time that processing is performed, greater convenience is afforded., Updating may take place prior to transmitting process data to the device, or after transmitting. It may be carried out at various timing.

It would also be possible to predict, from the manner in which money information is consumed during a predetermined time interval, the date on which the remaining balance of money information will be used up, and to then inform the user, or to have the usage control apparatus acquire money information from the server before the money information is completely used up.

The device may additionally comprise a redelivery module for transmitting to the usage control apparatus an updated value of the money information that has been updated according to the amount of processing specified by the process data.

By so doing, when money information is held by the usage control apparatus, money information can be held on a consistent basis by the usage control apparatus. Since no particular modifications to money information are made by the usage control apparatus, fraud may be avoided. For example, where money information is encrypted by the server issuing the money information or by the device prior to being transmitted to the usage control apparatus, the likelihood of improper modification of money information at the usage control apparatus can be minimized.

The device may additionally comprise an output module for outputting, on the device and/or on the usage control apparatus, money information that has been requested and used for the process, and/or unused money information that is held by the device and/or the usage control apparatus.

By so doing, the user may be apprised of amounts of money information used and of unused money information, whereby the user can adjust the amount of money information to be used. The user may also acquire more money information when the balance of unused money information drops to a low level.

Where the amount of unused money information is output, the output module may output the amount of money information useable by the usage control apparatus.

The device may identify a usage control apparatus that has transmitted a process instruction, and output the amount of money information useable by this usage control apparatus. This is effective where a number of usage control apparatuses output process instructions to a single device.

The device may be a printer, and the process data may be print data.

Various devices, such as a fax, are conceivable. For example, a printer is acceptable.

The money information of a device may include control information for determining whether the money information is useable;

and a process prohibiting module may be provided for deciding, based on the control information, whether the money information is useable, and if decided not useable, prohibiting the process.

The money information may be coin information permitting unit-based use of the device. The usage may be established based on at least one parameter selected from the amount of data processed by the device; consumed amount of an expendable consumed by the device; duration of use of the device; power consumed by the device; and number of times of use of the device.

The money information may be encrypted; and

the device may comprise

a key holding module for holding a key capable of decrypting the encrypted money information; and

a decrypting module for decrypting the encrypted money information with the key.

Where decryptable by a device, money information can be encrypted for transmission to the device, so as to prevent unauthorized access to the money information during transmission. Encryption may be performed by a server issuing the money information, or by a usage control apparatus. Money information corresponding to “change” may be encrypted by the device.

By encrypting such that is can only be decrypted by the device, or by assigning a unique number to money information to enable identification, it is possible to prevent money information from being diverted for use in another device. By capturing and discriminating money information, it is possible to prevent improper reuse of money information.

For example, money information 51 may pertain to a quantity of toner or to a period of use of printer 40. Still more intricate settings, such as dot count or area of the paper used, are possible as well. Money information 51 is not limited to coin information 51c; other information which is a variable representing amount of processing as a number value is acceptable. Coin information 51c may be provided in a plurality of “denominations” corresponding to those in the real world, such as ¥10, ¥5 etc.

When money information 51 is issued by the server 20, information such as the MAC address of the client 30 can be appended to the money information 51. In this case, the printer 40 compares the MAC address of the client 30 with the MAC address of the sender, and if the two match, performs printing. By so doing, even if money information 51 should be stolen, the unauthorized user will not be able to print. A client 30 may be identified in other ways, even without an appended MAC address.

The description of protocol, data or application may be appended to money information 51, and printing performed on when these match.

It would also be possible to predict, from the manner in which money information 51 is consumed during a predetermined time interval, the date on which money information 51 will be used up, and to then inform the user, or to acquire additional money information 51 from the server 20 before it is completely used up.

A predetermined amount of money information may be allotted at the beginning of each month, for example, to enable printing up to a defined monetary amount per month. Of course, daily or weekly units may be used instead of monthly units.

Money information 51 may be issued for use by groups, rather than by individuals. That is, MAC addresses for a plurality of clients 30 may be appended to money information. By so doing, use of a printer can be administered on a department basis, for example.

A MAC address enabling identification of a printer 40 and client 30 may be appended to money information 51. Where a printer 40 is set up so that it can use only money information 51 having its own MAC address appended, it is possible to designate a printer 40 for use by a particular client 30. A plurality of MAC addresses of printers 30 may be appended.

When money information 51 is issued by a server 20, various different monetary amounts may be established for different clients 30. Money information 51 in various different monetary amounts may be issued by means of useable time.

While the invention has been described with reference to preferred exemplary embodiments thereof, it is to be understood that the invention is not limited to the disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more less or only a single element, are also within the spirit and scope of the invention.

1. A usage control apparatus for controlling use of a device, comprising:
a holding module configured to hold money information requested when the device is made to perform a process that uses the device for predetermined usage; and
a transmitting module configured to transmit the money information to the device at the time of processing by the device.

2. A usage control apparatus according to claim 1, wherein the transmitting module transmits process data for processing by the device to the device.

3. A usage control apparatus according to claim 2, further comprising a controller configured to control whether the processing may proceed or not, by comparing an amount of processing specified by the process data, with an allowable amount of processing indicated by the money information.

4. A usage control apparatus according to claim 2, further comprising
a money information updating module configured to update the money information according to an amount of processing specified by the process data.

5. A usage control apparatus according to claim 2, wherein the transmitting module transmits the money information in an amount required for an amount of processing specified by the process data.

6. A usage control apparatus according to claim 2, wherein the transmitting module transmits the money information held by the holding module; and
the usage control apparatus further comprises
a receiving module which receives from the device an updated value of the money information updated according to an amount of processing specified by the process data.

7. A usage control apparatus according to claim 2, wherein the device is a printer, and the process data is print data.

8. A usage control apparatus according to claim 1, wherein the holding module acquires and holds the money information from a server connected via a network.

9. A usage control apparatus according to claim 8, wherein the holding module notifies the server of an amount of money information that has not been used.

10. A usage control apparatus according to claim 1, wherein the money information includes control information which is usable for determining whether the money information is useable; and
the usage control apparatus further comprises:
a transmission controller which decides, based on the control information, whether the money information is useable, and if the money information is not useable, prohibits transmission of the money information.

11. A usage control apparatus according to claim 1, wherein the money information is coin information permitting unit-based use of the device.

12. A usage control apparatus according to claim 1, wherein
the usage is established based on at least one selected from an amount of data processed by the device; consumed amount of an expendable consumed by the device; duration of use of the device; power consumed by the device; and number of times of use of the device.

13. A usage control apparatus for using a device for which predetermined money information is requested depending on usage, the usage control apparatus comprising:
a holding module configured to acquire, from a server connected to the usage control apparatus via a network, money information in an amount requested for using the device by a predetermined amount, and to hold the money information; and
a transmitting module configured to transmit to the device process data for processing by the device;
wherein the transmitting module further transmits to the device, from the money information held by the holding module, the money information in at least an amount requested for causing the device to process the process data.

14. A usage control apparatus according to claim 13, wherein the transmitting module transmits to the device, together with the process data, the money information in an amount requested for causing the device to process the process data; and
the usage control apparatus further comprises
an updating module which updates the money information held in the holding module by deducting the money information in an amount transmitted to the device.

15. A usage control apparatus according to claim 13, wherein
the transmitting module transmits to the device all the money information held in the holding module; and
the usage control apparatus further comprises:
a receiving module configured to receive from the device the money information that has been transmitted to the device and was deducted in an amount requested for causing the device to process and to store the money information in the holding module.

16. A device, comprising:
a process command receiving module configured to receive a process command from a usage control apparatus for controlling a process;
a decision module configured to decide whether or not to enable the process based on the process command, depending on whether money information requested when the device performs the process that uses the device for predetermined usage is held in the device and/or in the usage control apparatus; and
a processing module configured to perform the process, in the event that the decision module has decided to enable processing.

17. A device according to claim 16, wherein process data targeted for the process is received as the process command.

18. A device according to claim 17, further comprising:
a managing module configured to manage the money information; and
a updating module configured to update the money information depending on an amount of processing specified by the process data.

19. A device according to claim 17, further comprising
a redelivery module which transmits to the usage control apparatus an updated value of the money information that has been updated according to an amount of processing specified by the process data.

20. A device according to claim 17, further comprising:
an output module configured to output, on the device and/or on the usage control apparatus, an amount of money information that has been requested and used for the process, and/or
an amount of money information that has not been used and is held by the device and/or the usage control apparatus.

21. A device according to claim 20, wherein
the output module, in the event of outputting the amount of unused money information, outputs an amount of money information useable by the usage control apparatus.

22. A device according to claim 17, wherein
the device is a printer, and the process data is print data.

23. A device according to claim 16, further comprising
a receiving module which receives the money information at the time of execution of the process.

24. A device according to claim 16, wherein
the money information includes control information for determining whether the money information is useable; and
the device further comprises
a process prohibiting module which decides, based on the control information, whether the money information is useable, and if decided not useable, prohibits the process.

25. A device according to claim 16, wherein
the money information is coin information permitting unit-based use of a fixed usage.

26. A device according to claim 16, wherein
the usage is established based on at least one selected from the amount of data processed by the device; consumed amount of an expendable consumed by the device; duration of use of the device; power consumed by the device; and number of times of use of the device.

27. A device according to claim 16, wherein
the money information is encrypted; and
the device further comprises:
a key holding module which holds a key capable of decrypting the encrypted money information; and
a decrypting module which decrypts the encrypted money information with the key.

28. Device for executing a process in exchange for money information, the device comprising:
a holding module which
receives, from a usage control apparatus connected to the device, money information in an amount for using the device for predetermined amount and holds the money information;
a receiving module receives process data for processing from the usage control apparatus;
a processing module able to execute the process; and
a decision module that, in the event that an amount of money information required for processing the process data is less than an amount of money information held in the holding module, causes the processing module to execute the process.

29. A device according to claim 28, further comprising:
a transmitting module which transmits to the usage control apparatus money information that has been held in the holding module and was deducted money information in an amount required for processing of the process data.

30. A device according to claim 28, further comprising
an updating module which updates the money information by deducting money information in an amount required for processing of the process data from the money information held in the holding module.

31. A method for controlling use of a device, comprising the steps of:
holding money information requested when the device is made to perform a process that uses the device for predetermined usage; and
transmitting the money information to the device at the time of processing by the device.

32. A method for using a device for which predetermined money information is requested depending on usage, the method comprising the steps of:
acquiring and holding money information in an amount requested for using the device by a predetermined amount; and
transmitting to the device process data for processing by the device;
transmitting to the device, from the money information held, the money information in at least an amount requested for causing the device to process the process data.

33. A method for controlling a device, comprising the steps of:
receiving a process command from a usage control apparatus for controlling a process;
deciding whether to enable a process based on the process command, depending on whether money information requested when the device performs the process that uses the device for predetermined usage is held in the device and/or in the usage control apparatus; and
performing the process, in the event that the decision is enabled.

34. A method for executing a process in exchange for money information, the method comprising the steps of:
receiving and holding money information in an amount requested in exchange for executing a predetermined amount of process;
receiving process data for processing;
executing the process in the event that an amount of money information required for processing the process data is less than an amount of money information held.
